(19) United States
(12) Patent Application Publication
(10) Pub. No.: US 2023/0321930 A1
(43) Pub. Date: Oct. 12, 2023

(54) COMPOSITE COMPONENT AND METHOD FOR PRODUCTION THEREOF

(71) Applicant: Kape GmbH, Linz (AT)

(72) Inventors: Peter KARACSONYI, Linz (AT); Daniel JAHN, Seekirchen (AT)

(73) Assignee: Kape GmbH, Linz (AT)

(21) Appl. No.: 18/120,619

(22) Filed: Mar. 13, 2023

(30) Foreign Application Priority Data
Apr. 6, 2022 (EP) 22 166 947.6

(51) Int. Cl. B29C 70/48; B29C 70/08

(52) U.S. Cl. CPC B29C 70/48; B29L 2031/52; B29C 70/086

(57) ABSTRACT

The present disclosed subject matter relates to a method for producing a composite component, in particular for a gliding board, roller board or skateboard. The method comprises introducing a bottom mat made of reinforcing fibers, above this a flat core made of plastic, and above this a top mat made of reinforcing fibers into an opened mold, closing the mold, introducing an uncured plastics matrix into the closed mold, allowing the plastics matrix to cure in the closed mold, opening the mold, and demolding the composite component. The core is provided on its lower and upper sides with a plurality of spacer nubs, which keep the bottom and top mats in the closed mold at a distance from the lower and upper sides.

### CROSS-REFERENCE TO RELATED APPLICATIONS

This application claims priority to the European Patent Application No. 22 166 947.6 filed Apr. 6, 2022, the disclosure of which is incorporated herein by reference.

### TECHNICAL FIELD

The present disclosed subject matter relates to a method for producing a composite component, in particular for a gliding board, roller board or skateboard, said method comprising introducing a bottom mat made of reinforcing fibers, above this a flat core made of plastic, and above this a top mat made of reinforcing fibers into an opened mold, closing the mold, introducing an uncured plastics matrix into the closed mold, allowing the plastics matrix to cure in the closed mold, opening the mold, and demolding the composite component. The disclosed subject matter also relates to a composite component produced by this method.

### BACKGROUND

Currently, skateboards, cruiser boards, longboards, snowboards, bigfoots and other gliding and roller boards, referred to here as “boards” for short, are made predominantly of glued laminated wood with usually seven different layers, sometimes also with bamboo and glass or carbon fiber layers. The elastic fiber structure of the wood layers gives the board inner tension and a dynamic response behavior with high linear elasticity, called “pop”, which is indispensable for ambitious and professional boarders. However, due to the individual structure of wood, such boards have inhomogeneous mechanical properties in mass production and tend to lose tension or pop due to ageing, moisture absorption (“soggy board”), abrasion (“razor tail”) and deformation. Due to the low tensile strength of wood, wooden boards may also break easily, which can lead to dangerous accidents. For example, the lifespan of wooden skateboards in the professional sector is only one to two days. The production of wooden boards is also extremely time-consuming, because the wood and other layers have to be glued, pressed and then manually milled, drilled, sawn and sanded.

Several attempts have already been made to use fiber-reinforced plastics in layered construction instead of wood for the production of boards. For example, US 2006/0097469 A1 describes a skateboard comprising a sandwich consisting of a plastics core made of PVC and glass fiber mats resting thereagainst, the sandwich being embedded in a plastics matrix made of epoxy, polyester or polyurethane resins. The sandwich is produced in a reaction injection molding process by introducing it into a mold and then injecting the as yet uncured resin, which then cures in the mold. Except for some longitudinal grooves on the upper and lower sides of the core, which are intended to facilitate the soaking of the fiber mats when injecting the resin, the fiber mats rest directly against the upper and lower sides of the core.

However, the plastics board produced by the method of US 2006/0097469 A1 and also other plastics boards mostly produced by lamination (see for example FR 2772624 A1 and US 2006/0049596 A1) are in no way comparable to wooden boards in terms of their dynamic response behavior (“pop”), thus making them unsatisfactory for professional boarders. Also in other applications, for example in the automotive industry, the known composite components often suffer from a lack of strength and sufficient elasticity.

### BRIEF SUMMARY

The present disclosed subject matter aims to overcome the disadvantages of the stated prior art and to create a composite component, in particular a gliding board, roller board or skateboard, made of fiber-reinforced plastic, which is particularly resistant, has long-lasting dynamic response behavior or pop, is lightweight and can also be produced easily and inexpensively in complex forms.

This objective is achieved in a first aspect of the disclosed subject matter with a method for producing a composite component, in particular for a gliding board, roller board or skateboard, said method comprising introducing a bottom mat made of reinforcing fibers, above this a flat core made of plastic, and above this a top mat made of reinforcing fibers into an opened mold, closing the mold, introducing an uncured plastics matrix into the closed mold, allowing the plastics matrix to cure in the closed mold, opening the mold, and demolding the composite component, wherein the core is provided on its lower and upper sides with a plurality of spacer nubs, which keep the bottom and top mats in the closed mold at a distance from the lower and upper sides.

The disclosed subject matter is based on a special reaction injection molding process in which a core equipped with nubs is used in a sandwich formed of fiber mat, core and fiber mat, wherein the plastics matrix flows over the fiber mats on their sides facing the core, so that an intermediate layer of the plastics matrix is formed there. The final sandwich thus consists of fiber mat-in-plastics matrix, plastics matrix intermediate layer, core, plastics matrix intermediate layer, and fiber mat-in-plastics matrix, i.e. is at least five-layered, wherein the height of the nubs determines the thickness of the plastics matrix intermediate layers between the core and the fiber mats. By varying the height of the spacer nubs and thus the density of the intermediate layers, the strength and elasticity of the composite component can be optimally adjusted and thus, for example, a board with excellent and long-lasting pop can be achieved.

Optionally, the spacer nubs have a height of 0.5-2.5 mm, e.g., 1-2 mm. This results in a corresponding thickness of the plastics matrix intermediate layers between the core and the bottom and top mats. This layer thickness results in a good force distribution in the component and thus good overall strength with simultaneous elasticity.

It is particularly expedient if the spacer nubs have a diameter of 1-5 mm, e.g., 2-4 mm, and their mutual spacing is greater than their diameter. This allows the plastics matrix to flow unhindered in the directions of the areal extent of the core between the spacer nubs along the lower and upper sides of the core and can thus also wet the bottom and top mats over a large area. The spacer nubs form only small “islands” here in the plastics intermediate layers between the core and the bottom and top mats.

In a further embodiment of the method according to the disclosed subject matter, the core is also provided on its lower and upper sides with some fixing nubs which are higher than the spacer nubs and, when the mold is closed, partially penetrate into the bottom and top mats and press the latter against the mold so as to fix the sandwich formed of bottom mat, core and top mat in the mold during the introducing and curing of the plastics matrix.

Optionally, the fixing nubs have a height of 1-5 mm, e.g., 2-4 mm. The fixing nubs thus only slightly compress or penetrate the bottom and top mats when these have a thickness for example of 5-10 mm, which is sufficient for fixing the sandwich in the mold without significantly affecting the strength and elasticity of the final composite component.

In principle, the core can be made of any plastic. However, it is particularly advantageous if the core is made of foam, which results in a particularly lightweight component. Optionally, the core is made of foamed polycaprolactam (polyamide 6), which gives the composite component high elasticity with low weight.

The plastics matrix can in principle be formed from any plastic that can be cured in the mold (“in situ”), for example a two-component epoxy resin. It is particularly expedient if the plastics matrix is based on caprolactam, so that it polymerises to polycaprolactam (polyamide 6) after curing and can thus form a particularly intimate bond with a foam core, in particular a foam core made of foamed polycaprolactam.

According to a further optional feature of the disclosed subject matter, the fiber mats contain glass, carbon and/or polyamide fibers. It is particularly favorable if the fiber mats are made exclusively of polyamide fibers, which gives particularly high strength and good pop. These fibers can be in the form of nonwovens, laid scrims, woven fabrics or knitted fabrics as mats. In particular, such fiber mats can also be pre-formed to best fit the upper and lower sides of the core, i.e. as so-called “pre-forms”, which contain for example thin, thermoplastically deformable polyamide threads. With the help of such thermoplastic threads, the fiber mats can be pre-formed under heat before they are inserted into the mold under and over the core.

In a second aspect, the disclosed subject matter also provides a composite component, in particular for a gliding board, roller board or skateboard, comprising a sandwich formed of a bottom mat made of reinforcing fibers, above this a flat core made of plastic, and above this a top mat made of reinforcing fibers, the sandwich being embedded in a plastics matrix formed by reaction injection molding, wherein the composite component is distinguished in accordance with the disclosed subject matter in that the core is provided on its lower and upper sides with a plurality of spacer nubs which hold the bottom and top mats at a distance from the lower and upper sides, which distance is filled by the plastics matrix.

With regard to its advantages and further optional embodiments of the composite component according to the disclosed subject matter, reference is made to the above explanations of the method according to the disclosed subject matter.

### BRIEF DESCRIPTION OF THE DRAWINGS

The disclosed subject matter is explained in greater detail below with reference to exemplary embodiments shown in the accompanying drawings. In the drawings:

FIG. 1 shows the composite component (here: a skateboard deck) of the disclosed subject matter in a perspective view from below;

FIG. 2 shows part of the composite component and the method for production thereof according to the disclosed subject matter in a sectional view through the filled and closed reaction injection mold during production;

FIG. 3 shows the core of the composite component of FIGS. 1 and 2 in a perspective view from obliquely above; and

FIG. 4 shows on an enlarged scale the detail IV from FIG. 3.

### DETAILED DESCRIPTION

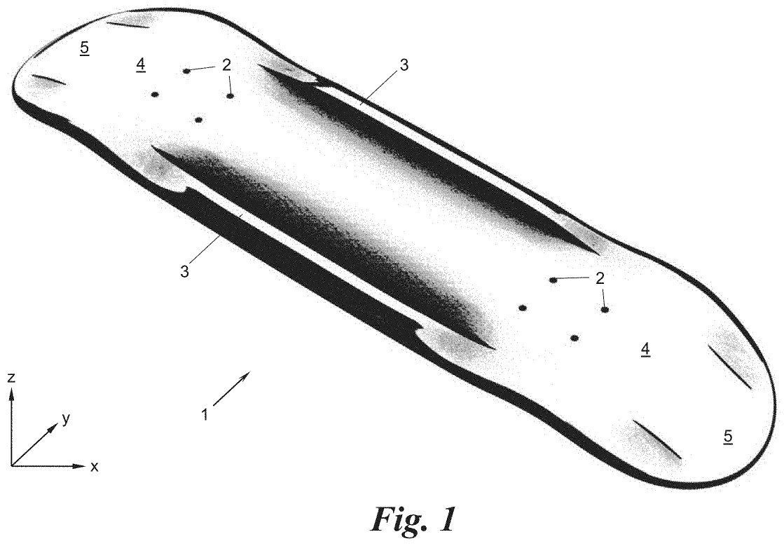

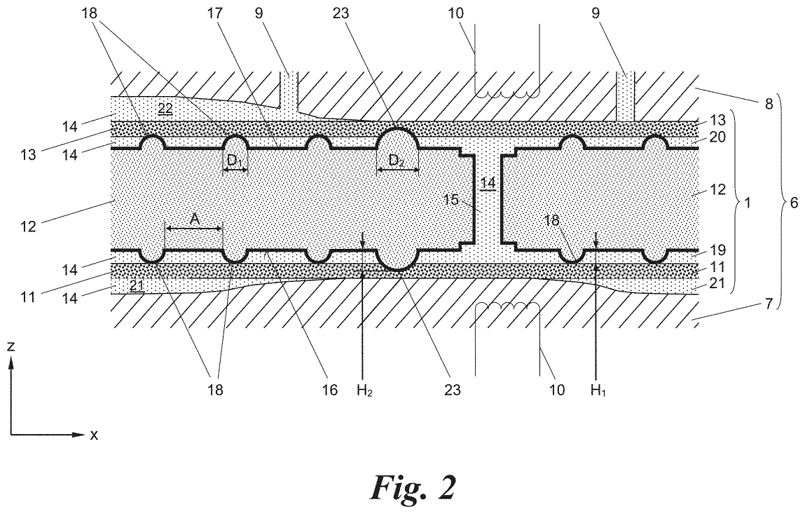

FIG. 1 shows an exemplary composite component 1, which has been produced using the method explained with reference to FIG. 2-4. The composite component 1 can be any flat component, i.e. a component with a pronounced areal extent (here: in the x/y plane). It is understood that the component 1 does not have to be planar; it can also have a curved surface and in particular also a varying thickness normal to its areal extent, here: in the z-direction.

For example, the composite component 1 is a body part in the automotive or aerospace industry, a building panel in the construction industry, or similar. In the example shown, the composite component 1 is a sliding or roller board (“board”), in particular a skateboard or skateboard deck with holes 2 on its underside for anchoring wheelsets (not shown). It could also be any other type of board, for example a cruiser board, longboard, snowboard, monoski, bigfoot, or the like.

On the underside of the composite component 1, here: the board, slide rails 3 can be formed or flat support surfaces 4 can be molded in for board, lip, nose or tail slides. The ends 5 can be curved upwardly in a shovel-like manner in order to be able to jump by stepping on the shovel faces (“ollie”). The upper side of the board may have concave areas for a secure grip.

According to FIG. 2, the composite component 1 (only a part of which is shown in section here) is produced in a special injection molding process. For this purpose, a mold 6 consisting of two mold halves 7 (female) and 8 (male) is used, which can be opened and closed and has sprue channels 9 and optionally a heating device 10, as known in the art.

First, a stack or sandwich formed of a bottom mat 11, a core 12, and a top mat 13 is introduced into the opened mold 6. Then, the mold 6 is closed and an as yet uncured plastics matrix 14 is introduced into the closed mold 6 via the sprue channels 9. The matrix can be introduced here under pressure or without pressure (by “forcible filling” or “allowing it to trickle in”, respectively), both of which methods are also referred to here by the term “injection”. The plastics matrix 14, which as yet is uncured, wets and saturates the bottom and top mats 11, 13 and fills all the gaps remaining in the mold 6, including any apertures 15 in the core 12. The plastics matrix 14 is then allowed to cure in the mold 6, if necessary with appropriate temperature control of the mold 6 by means of the heating devices 10.

When the plastics matrix 14 cures, it polymerises to form a rigid plastics polymer. After allowing the plastics matrix 14 to cure in the mold 6, the latter is opened by separating the mold halves 7, 8, and the finished composite component 1 is demolded from the mold 6.

The production of an injection-molded article, such as the composite component 1, in a mold 6 by “in situ” curing of a plastics matrix 14 is also referred to as reaction injection molding (RIM) or resin transfer molding (RTM). All RIM and RTM process parameters and options known in the art can be used to perform reaction injection molding of the plastics matrix 14 in the mold 6.

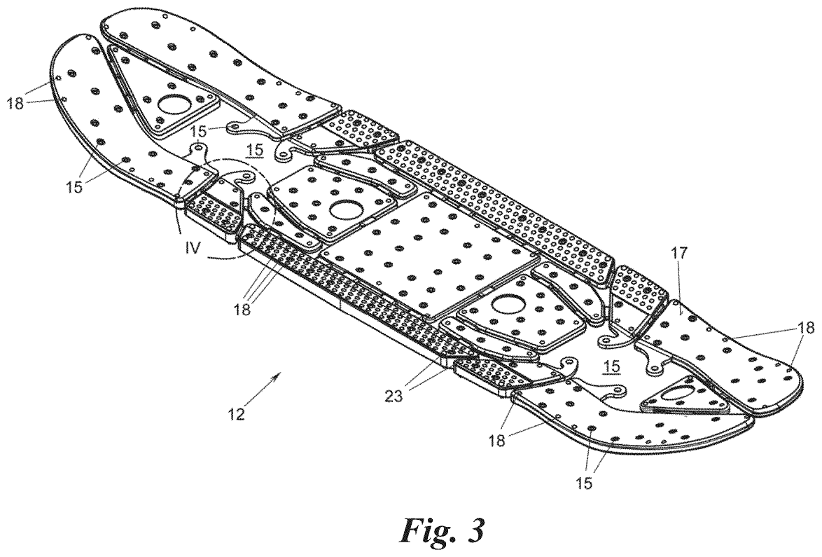

The core 12 can be made of any plastic, for example a thermoset or thermoplastic made of polyurethane, polycarbonate or polyamide (PA), in particular PA6, PA11 or PA12. The core 12 may be a solid or hollow core and optionally provided with a plurality of apertures 15, in particular in the z-direction, as shown in FIG. 3.

For a particularly lightweight core 12, this can be made of foamed plastic (“foam”), for example foamed polycaprolactam (polyamide 6, PA6). The core 12 can also be made of more than one plastic, for example of a resin plastic for mechanical stability, filled with a foamed plastic, optionally provided with apertures 15.

The bottom and top mats 11, 13 are each single- or multi-layer nonwovens, laid scrims, woven fabrics or knitted fabrics made of reinforcing fibers that can be wetted and saturated with the plastics matrix 14, for example made of glass fibers, carbon fibers, aramid fibers, basalt fibers, flax fibers, polyamide fibers or combinations thereof. In an optional embodiment, the bottom and top mats 11, 13 are made exclusively of polyamide fibers.

The fibers can be laid uni-, bi- or multi-directionally in the bottom and top mats 11, 13, also in different layers in different directions. The bottom and top mats 11, 13 can optionally be composed of several parts (“patches”) lying next to each other—if necessary also with mutual spacing—wherein in a multi-layer bottom or top mat 11, 13 also only individual layers may be formed by such patches.

The bottom and top mats 11, 13 can additionally contain some thin thermoplastic threads, for example polyamide threads, which allow a thermal pre-deformation of the bottom and top mats 11, 13 by heating, deforming and cooling down again, in order to pre-adapt already in advance them to a possible surface curvature of the core 12.

The plastics matrix 14 may be made of any thermoset or thermoplastic suitable for reaction injection molding, for example a two-component low-viscosity plastics resin which cures in the mold 6 after having been introduced into it. For example, the plastics matrix 14 is based on polyurethane or epoxy resin. A particularly suitable base for the plastics matrix 14 is caprolactam (polyamide 6), which cross-links to form polycaprolactam through appropriate activation, for example ring-opening polymerisation by the addition of water (“hydrolytic ring opening”).

A plastics matrix 14 based on caprolactam is particularly suitable for use with a core 12 made of foamed polycaprolactam, because the material identity of the core 12 and plastics matrix 14 results in a particularly intimate bond of the composite component 1.

As shown in FIG. 2 to 4, the core 12 is provided with a plurality of spacer nubs 18 on its lower side 16 or upper side 17, in particular on both the lower side 16 and the upper side 17. The spacer nubs 18 hold the bottom and top mats 11, 13 at a distance H1 from the lower and upper side 16, 17, respectively, of the core 12 when the sandwich 11-13 is formed. When the uncured plastics matrix 14 is introduced into the mold 6, this distance H1 is also completely filled with plastics matrix 14 and thus results in intermediate layers 19 and 20 in the finished composite component 1, one between the bottom mat 11 and the core 12, and one between the core 12 and the top mat 13. The composite component 1 thus becomes a composite component formed of at least five layers (11, 19, 12, 20, 13).

As shown in FIG. 2, the mold 6 may also have mold cavities or recessed areas below the bottom mat 11 and above the top mat 13, which lead to additional plastics matrix layers 21, 22 below and above the bottom and top mats 11, 13, respectively, so that the composite component 1 may also have six or seven layers. The layers 21, 22 can be used, for example, for integral molding of the slide rails 3.

The distance H1 and thus the thickness of the plastics matrix layers 19, 20 is equal to the height of the spacer nubs 18, i.e. how the extent to which they project from the respective lower or upper side 16, 17 of the core 12. The strength and elasticity properties of the composite component 1 can thus be varied by selecting the height H1 of the spacer nubs 18, and thus the thickness of the layers 19, 20, accordingly. For the manufacture of a skateboard with a length of, for example, 60-80 cm, for example spacer nubs 18 with a height H1 of 0.5 to 2.5 mm are suitable, e.g., 1-2 mm, say, about 1 mm.

The diameter D1 of the spacer nubs 18 and their mutual (minimum) spacing A on the lower and upper sides 16, 17 is selected to ensure unobstructed passage of the uncured plastics matrix 14 when this is introduced into the gap between the core 12 and the bottom and top mats 11, 13. The height H1, the diameter D1 and the minimum spacing A of the spacer nubs 18 are further selected according to the desired ratio of core material of the spacer nubs 18 to plastics matrix material of the intermediate layers 19, 20 in order to achieve the desired strength and elasticity properties of the finished composite component 1. For example, for a skateboard with a length of, for example, 60-80 cm, the spacer nubs 18 for example have a diameter D1 of 1-5 mm, e.g., 2-4 mm, say, about 2 mm, and their mutual minimum spacing A is greater than their diameter D1, for example at least one to two times their diameter D1.

It is understood that the spacer nubs 18 may have any cross-sectional shape in plan view, whether round (as shown), oval, rectangular, square, pentagonal, hexagonal, any polygonal shape, or the like. They can also have any cross-sectional shape in the side view, for example circular arc-shaped (as shown), triangular, trapezoidal, rectangular, square, etc. More generally, they can be dome-shaped (as shown), pyramid-shaped, truncated pyramid-shaped, cone-shaped, truncated cone-shaped, cylindrical, prismatic or the like. As shown in FIG. 3, the spacer nubs 18 can also be distributed unevenly over the respective lower or upper side 16, 17, for example more densely in edge or outwardly bulged areas of the composite component 1 and more sparsely in central or recessed areas of the composite component 1.

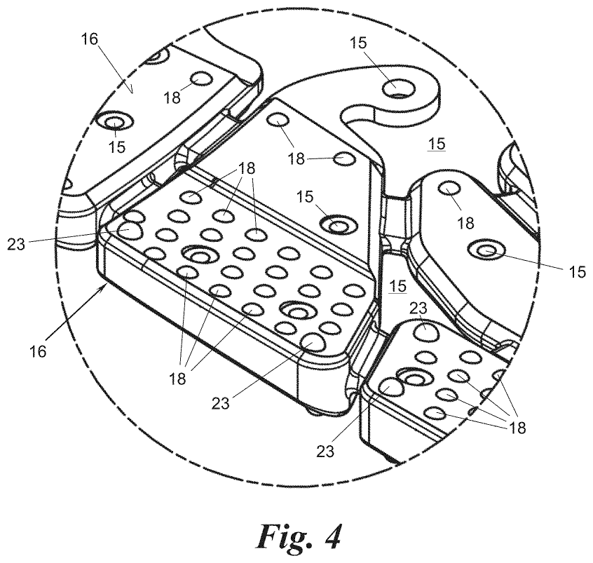

According to FIGS. 2 and 4, the core 12 may optionally be provided with a plurality of distributed fixing nubs 23 on its lower and/or upper sides 16, 17. The fixing nubs 23 have a greater height H2 than the height H1 of the spacer nubs 18. If the fixing nubs 23 are arranged at such positions of the lower and upper sides 16, 17 where the mold 6 has no areas receding from the bottom and top mats 11, 13 for the formation of layers 21, 22, then the fixing nubs 23 partially penetrate into the bottom and top mats 11, 13 when the mold 6 is closed, i.e. compress them locally there; see FIG. 2. Thus, the sandwich formed of bottom mat 11, core 12 and top mat 13 is pressed there between the mold halves 7, 8 and thus fixed against shifting in the mold 6 during the introduction and curing of the plastics matrix 14.

The fixing nubs 23—similarly to the spacer nubs 18—can also have any cross-section in plan and side view and can be, for example, dome-shaped (as shown), pyramid-shaped, truncated pyramid-shaped, cone-shaped, truncated cone-shaped, cylindrical, prismatic, or the like.

For a skateboard with a length of, for example, 60-80 cm, the fixing nubs 23 have, for example, a height H2 of 1-5 mm, e.g., 2-4 mm, say, about 2 mm. The fixing nubs 23 have a correspondingly larger diameter D2, for example from 1-10 mm, e.g., 3-6 mm, say, about 4 mm.

It is understood that for larger composite components 1, the heights H1, H2, the diameters D1, D2 and the spacing A of the spacer and fixing nubs 18, 23 can be scaled accordingly.

The disclosed subject matter is not limited to the embodiments shown, but encompasses all variants, modifications and combinations thereof which fall within the scope of the appended claims.

What is claimed is:

1. A method for producing a composite component, said method comprising introducing a bottom mat made of reinforcing fibers, above the bottom mat a flat core made of plastic, and above the flat core a top mat made of reinforcing fibers into an opened mold, closing the mold, introducing an uncured plastics matrix into the closed mold, allowing the plastics matrix to cure in the closed mold, opening the mold, and demolding the composite component, wherein the core is provided on lower and upper sides of the core with a plurality of spacer nubs, which keep the bottom and top mats in the closed mold at a distance from the lower and upper sides.

2. The method according to claim 1, wherein the spacer nubs have a height of 0.5-2.5 mm.

3. The method according to claim 1, wherein the spacer nubs have a diameter of 1-5 mm and their mutual spacing is greater than their diameter.

4. The method according to claim 1, wherein the core is also provided on said lower and upper sides with some fixing nubs which are higher than the spacer nubs and, when the mold is closed, partially penetrate into the bottom and top mats and press the bottom and top mats against the mold so as to fix the sandwich formed of bottom mat, core and top mat in the mold during the introducing and curing of the plastics matrix.

5. The method according to claim 4, wherein the fixing nubs have a height of 1-5 mm.

6. The method according to claim 1, wherein the core is made of foam.

7. The method according to claim 1, wherein the core is made of foamed polycaprolactam.

8. The method according to claim 1, wherein the plastics matrix is based on caprolactam.

9. The method according to claim 7, wherein the plastics matrix is based on caprolactam.

10. The method according to claim 1, wherein the fiber mats contain one or more elements of the list: glass fibers, carbon fibers, polyamide fibers.

11. The method according to claim 1, wherein the fiber mats are made exclusively from polyamide fibers.

12. A composite component, comprising a sandwich formed of a bottom mat made of reinforcing fibers, above the bottom mat a flat core made of plastic, and above the flat core a top mat made of reinforcing fibers, the sandwich being embedded in a plastics matrix formed by reaction injection molding, wherein the core is provided on lower and upper sides of the core with a plurality of spacer nubs which hold the bottom and top mats at a distance from the lower and upper sides, which distance is filled by the plastics matrix.

13. The composite component according to claim 12, wherein the spacer nubs have a height of 0.5-2.5 mm.

14. The composite component according to claim 12, wherein the core is also provided on said lower and upper sides with some fixing nubs which are higher than the spacer nubs and penetrate partially into the bottom and top mats.

15. The composite component according to claim 12, wherein the core is made of foam.

16. The composite component according to claim 12, wherein the core is made of foamed polycaprolactam.

17. The composite component according claim 12, wherein the plastics matrix is based on caprolactam.

18. The composite component according to claim 12, wherein the fiber mats contain one or more elements of the list: glass fibers, carbon fibers, polyamide fibers.

19. The composite component according to claim 12, wherein the fiber mats are made exclusively from polyamide fibers.

20. The composite component according to claim 12, wherein the core has a plurality of apertures filled by the plastics matrix.

21. The composite component according to claim 12, wherein the composite component is a gliding board, roller board or skateboard.
